(19) United States
(12) Patent Application Publication
(10) Pub. No.: US 2026/0048740 A1
(43) Pub. Date: Feb. 19, 2026

(54) VEHICLE CONTROLLER, METHOD, AND COMPUTER PROGRAM FOR VEHICLE CONTROL

(71) Applicants: TOYOTA JIDOSHA KABUSHIKI KAISHA, Toyota-shi (JP); DENSO CORPORATION, Kariya-city (JP)

(72) Inventor: Satoru AKAHANE, Machida-shi (JP)

(73) Assignees: TOYOTA JIDOSHA KABUSHIKI KAISHA, Toyota-shi (JP); DENSO CORPORATION, Kariya-city (JP)

(21) Appl. No.: 19/255,232

(22) Filed: Jun. 30, 2025

(30) Foreign Application Priority Data
Aug. 16, 2024 (JP) 2024-135853

(51) Int. Cl. B60W 30/14; B60W 10/18; B60W 40/08; B60W 50/00; G06V 20/59

(52) U.S. Cl. CPC B60W 30/146; B60W 10/18; B60W 40/08; B60W 50/00; G06V 20/597; B60W 2050/0083; B60W 2420/403; B60W 2510/18

(57) ABSTRACT

A vehicle controller includes a processor configured to detect abnormality occurring in a driver of a vehicle, decelerate the vehicle so that a ratio of braking force of rear wheels of the vehicle to braking force of front wheels of the vehicle is a first ratio, when abnormality occurring in the driver is detected, and set the first ratio to a value greater than a second ratio. The second ratio is the ratio of braking force of the rear wheels to braking force of the front wheels for a case where the vehicle decelerates when an abnormality occurring in the driver is not detected.

### FIELD

The present invention relates to a vehicle controller that controls travel of a vehicle when an abnormality occurs with a driver, a method, and a computer program for vehicle control.

### BACKGROUND

A vehicle-mounted controller that operates appropriately in the event of an abnormality with a vehicle driver according to the type of the abnormality has been determined (see Japanese Unexamined Patent Publication No. 2021-77134). The vehicle-mounted controller operates according to the type of abnormality with a vehicle driver, based on the result of detection of the state of the driver's attention function and that of the state of the driver's autonomic nerves.

### SUMMARY

Depending on the type of abnormality occurring in a driver, jolting the driver may not be advisable.

It is an object of the present invention to provide a vehicle controller that can reduce jolting of a vehicle when decelerating the vehicle in response to an abnormality occurring in the driver.

According to an embodiment, a vehicle controller is provided, which includes a processor configured to: detect abnormality occurring in a driver of a vehicle, decelerate the vehicle so that a ratio of braking force of rear wheels of the vehicle to braking force of front wheels of the vehicle is a first ratio, when an abnormality occurring in the driver is detected, and set the first ratio to a value greater than a second ratio. The second ratio is the ratio of braking force of the rear wheels to braking force of the front wheels for a case where the vehicle decelerates when an abnormality occurring in the driver is not detected.

In an embodiment, the processor identifies a type of abnormality occurring in the driver, based on an interior sensor signal obtained by a vehicle interior sensor for sensing the driver's state; and the processor decelerates the vehicle at the first ratio when the type of abnormality occurring in the driver is a first type that does not allow jolting of the driver, and decelerates the vehicle at the second ratio when the type of abnormality occurring in the driver is a second type different from the first type.

According to another embodiment, a method for vehicle control is provided. The method includes: detecting abnormality occurring in a driver of a vehicle; decelerating the vehicle so that a ratio of braking force of rear wheels of the vehicle to braking force of front wheels of the vehicle is a first ratio, when abnormality occurring in the driver is detected; and setting the first ratio to a value greater than a second ratio. The second ratio is the ratio of braking force of the rear wheels to braking force of the front wheels for a case where the vehicle decelerates when an abnormality occurring in the driver is not detected.

According to still another embodiment, a non-transitory recording medium that stores a computer program for vehicle control is provided. The computer program includes instructions causing a processor mounted on a vehicle to execute a process including: detecting abnormality occurring in a driver of the vehicle; decelerating the vehicle so that a ratio of braking force of rear wheels of the vehicle to braking force of front wheels of the vehicle is a first ratio, when abnormality occurring in the driver is detected; and setting the first ratio to a value greater than a second ratio. The second ratio is the ratio of braking force of the rear wheels to braking force of the front wheels for a case where the vehicle decelerates when an abnormality occurring in the driver is not detected.

The vehicle controller of the present disclosure has an advantageous effect of being able to reduce jolts of a vehicle at decelerating the vehicle in response to the abnormality occurring in the driver.

### BRIEF DESCRIPTION OF DRAWINGS

FIG. 1 schematically illustrates the configuration of a vehicle control system equipped with a vehicle controller.

FIG. 2 illustrates the hardware configuration of an electronic control unit.

FIG. 3 is a functional block diagram of a processor of the electronic control unit, related to a vehicle control process.

FIG. 4A illustrates an example of time-varying changes in the braking force of front wheels and rear wheels for the case where a vehicle decelerates.

FIG. 4B illustrates an example of time-varying changes in the braking force of front wheels and rear wheels for the case where a vehicle decelerates.

FIG. 5 is an operation flowchart of the vehicle control process.

### DESCRIPTION OF EMBODIMENTS

A vehicle controller, a method for vehicle control executed by the vehicle controller, and a computer program for vehicle control will now be described with reference to the attached drawings. The vehicle controller has the function of an “emergency driving stop system (EDSS). ” When abnormality that makes it difficult for a driver to keep driving a vehicle is detected, the vehicle controller controls the vehicle according to emergency stop mode for automatically stopping the vehicle. To this end, the vehicle controller sets the ratio of braking force of rear wheels of the vehicle to braking force of front wheels of the vehicle, depending on the type of the detected driver's abnormality.

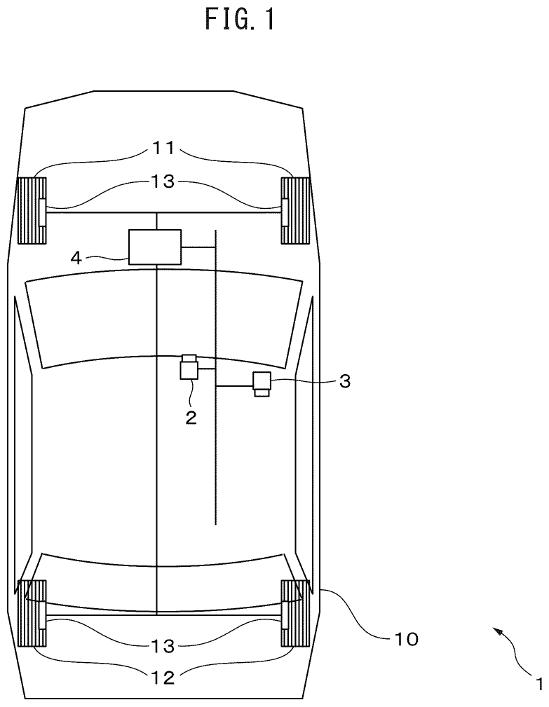

FIG. 1 schematically illustrates the configuration of a vehicle control system equipped with the vehicle controller. In the present embodiment, the vehicle control system 1, which is mounted on a vehicle 10 and controls the vehicle 10, includes a vehicle exterior camera 2, a driver monitoring camera 3, and an electronic control unit (ECU) 4, which is an example of the vehicle controller. The vehicle exterior camera 2 and the driver monitoring camera 3 are communicably connected to the ECU 4. The vehicle 10 may also include a range sensor (not illustrated) that measures the distances from the vehicle 10 to objects around the vehicle 10, such as LiDAR or radar. The vehicle 10 may further include a position determining device (not illustrated) that determines the position of the vehicle 10 on the basis of a satellite positioning system, such as a GPS receiver. The vehicle 10 may further include a notification device (not illustrated) for notification to occupants of the vehicle 10. The vehicle 10 may further include a wireless communication terminal (not illustrated) for wireless communication with another device.

The vehicle exterior camera 2, which is an example of a vehicle exterior sensor, is mounted on the vehicle 10 so as to be oriented to a predetermined region in an area around the vehicle 10, such as a region in front of the vehicle 10. The vehicle 10 may include multiple vehicle exterior cameras taking pictures in different orientations or having different focal lengths. Every predetermined capturing period, the vehicle exterior camera 2 captures the predetermined region to generate an image representing the predetermined region (hereafter a “vehicle exterior image”) and outputs the generated vehicle exterior image to the ECU 4.

The driver monitoring camera 3 is an example of the vehicle interior sensor for sensing the driver's state. The driver monitoring camera 3 is mounted near the top of the windshield or near an instrument panel and oriented to the driver so that at least the head of the driver sitting on the driver's seat of the vehicle 10 is included in the region to be captured by the camera. The driver monitoring camera 3 may include a light source, such as an infrared LED. Every predetermined capturing period, the driver monitoring camera 3 captures the region to be captured to generate an image representing the driver (hereafter a “driver image”) and outputs the generated driver image to the ECU 4. A driver image is an example of the interior sensor signal.

The ECU 4 functions as an EDSS. More specifically, when abnormality that prevents the driver from keeping driving the vehicle 10 is detected, the ECU 4 controls the vehicle 10 to make an emergency stop of the vehicle 10.

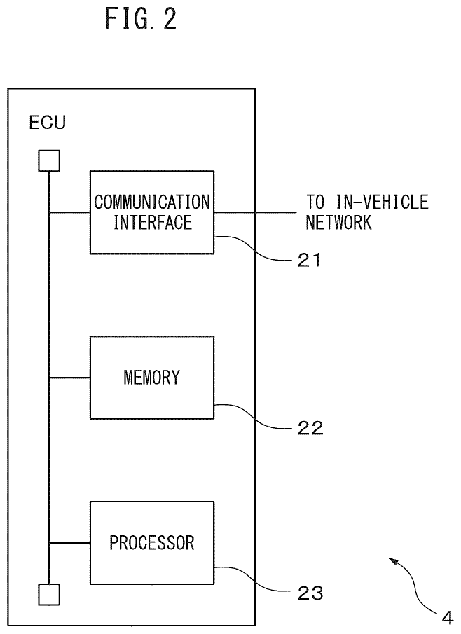

FIG. 2 illustrates the hardware configuration of the ECU 4. As illustrated in FIG. 2, the ECU 4 includes a communication interface 21, a memory 22, and a processor 23. The communication interface 21, the memory 22, and the processor 23 may be configured as separate circuits or a single integrated circuit.

The communication interface 21 includes an interface circuit for connecting the ECU 4 to another device inside the vehicle. The communication interface 21 passes a vehicle exterior image received from the vehicle exterior camera 2 and a driver image received from the driver monitoring camera 3 to the processor 23. In addition, the communication interface 21 outputs a control signal for controlling the vehicle 10.

The memory 22, which is an example of a storage unit, includes, for example, volatile and nonvolatile semiconductor memories, and stores various types of data used in a vehicle control process executed by the processor 23 of the ECU 4. For example, the memory 22 stores parameters of the vehicle exterior camera 2, such as its mounted position, orientation, and focal length. The memory 22 also stores various parameters used for detecting an abnormality occurring in the driver from driver images. In addition, the memory 22 temporarily stores vehicle exterior images and driver images received from the vehicle exterior camera 2 and the driver monitoring camera 3, respectively.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes a vehicle control process on the vehicle 10.

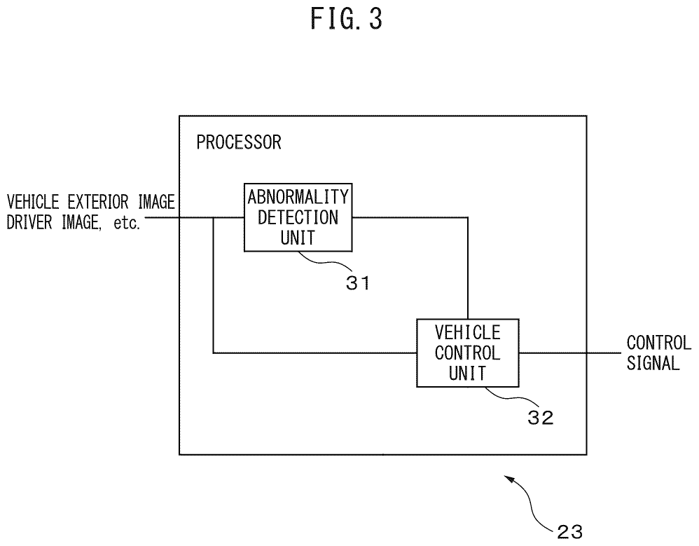

FIG. 3 is a functional block diagram of the processor 23, related to the vehicle control process. The processor 23 includes an abnormality detection unit 31 and a vehicle control unit 32. These units included in the processor 23 are, for example, functional modules implemented by a computer program executed by the processor 23, or may be dedicated operating circuits provided in the processor 23.

When abnormality that prevents keeping driving the vehicle 10 occurs in the driver, the abnormality detection unit 31 detects the abnormality. In addition, the abnormality detection unit 31 identifies the type of abnormality occurring in the driver. In the following, an abnormality which has occurred in the driver and prevents keeping driving the vehicle 10 will be referred to simply as “abnormality occurring in the driver,”for convenience of description.

The abnormality detection unit 31 inputs driver images in the order of generation into a classifier that has been trained to detect various abnormalities of a driver and to identify the type of abnormality. The classifier that detects a driver's abnormality and that identifies the type of abnormality is configured as a deep neural network (DNN) having a recursive structure, such as a recurrent neural network (RNN) or Long Short Term Memory (LSTM). The use of a DNN having a recursive structure as the classifier enables the abnormality detection unit 31 to use the driver's behavior depending on the abnormality occurring in the driver for detection of abnormality and identification of the type of abnormality, enabling accurate detection of abnormality and identification of the type of abnormality. The classifier may be configured based on another machine learning technique other than a DNN. The classifier is pre-trained in accordance with a predetermined supervised learning technique, such as backpropagation, using time-series images representing a driver in a normal state and multiple sets of time-series images prepared for respective types of abnormality to be detected and respectively representing a driver in these abnormal states as training images.

The classifier outputs a value indicating the presence or absence of an abnormality occurring in the driver and, when an abnormality occurring in the driver is detected, the type of abnormality (e.g., sleep, epilepsy, or a stroke).

The abnormality detection unit 31 may detect an abnormality occurring in the driver and identify the type of abnormality in accordance with another technique for detecting abnormality occurring in a driver from driver images and identifying the type of abnormality occurring in the driver.

When abnormality occurring in the driver is detected, the abnormality detection unit 31 instructs the vehicle control unit 32 to activate the EDSS function, i.e., to apply emergency stop mode, and notifies the vehicle control unit 32 of the value of a flag indicating the type of abnormality occurring in the driver. When an abnormality occurring in the driver is not detected, the abnormality detection unit 31 need not activate the EDSS function.

The vehicle control unit 32 executes control according to emergency stop mode to stop the vehicle 10, when an abnormality occurring in the driver is detected, i.e., when notified by the abnormality detection unit 31 that emergency stop mode will be applied.

First, in a control announcement phase, the vehicle control unit 32 informs the surroundings of the vehicle 10 that the vehicle 10 will make an emergency stop. To achieve this, the vehicle control unit 32 turns on the hazard lights, and notifies the occupants of the vehicle 10 that emergency stop mode will be executed, via a notification device (not illustrated). In addition, the vehicle control unit 32 may reduce the accelerator opening to decelerate the vehicle 10 slowly.

After a predetermined period (e.g., several seconds) in the control announcement phase, the vehicle control unit 32 decelerates the vehicle 10 to a predetermined low speed (e.g., 10 km/h) in a driving intervention phase. In addition to starting decelerating the vehicle 10, the vehicle control unit 32 honks the horn. The vehicle control unit 32 then searches the road shoulder of the road section being traveled by the vehicle 10 for a space where the vehicle 10 can stop, and sets such a space as a target stopping position. Alternatively, the vehicle control unit 32 may determine whether there is an evacuation space, such as a turnout, on the road section being traveled by the vehicle 10 within a predetermined distance of the current position of the vehicle 10 by referring to map information and the current position of the vehicle 10 determined by a position determining device (not illustrated). When there is such an evacuation space, the vehicle control unit 32 may set the evacuation space as a target stopping position.

To set a target stopping position, the vehicle control unit 32 determines the presence or absence of an obstacle that hinders the vehicle 10 from stopping on the road shoulder or the evacuation space, based on a vehicle exterior image obtained by the vehicle exterior camera 2.

Such an obstacle is, for example, a human, a motorcycle, a vehicle, a signboard, a block, a pole, or a pylon. The vehicle control unit 32 detects an obstacle by inputting a vehicle exterior image into a classifier that has been trained to detect an obstacle. The classifier is configured, for example, as a DNN having a convolutional neural network (CNN) or an attention mechanism.

The vehicle control unit 32 sets a real-space region corresponding to a region that is included in an area corresponding to the road shoulder or the evacuation space on the vehicle exterior image and that does not include a detected obstacle as a target stopping position. To this end, the vehicle control unit 32 identifies the area corresponding to the road shoulder or the evacuation space on the vehicle exterior image, based on the position of the vehicle 10 determined by the position determining device (not illustrated) mounted on the vehicle 10, the travel direction of the vehicle 10 measured by an orientation sensor (not illustrated) mounted on the vehicle 10, parameters of the vehicle exterior camera 2, such as the orientation and the angle of view, and map information. Alternatively, the vehicle control unit 32 may identify the area corresponding to the road shoulder or the evacuation space on the vehicle exterior image by detecting the road shoulder or the evacuation space from the vehicle exterior image. In this case, the classifier for detecting an obstacle is pre-trained to detect the road shoulder or the evacuation space as well; the vehicle control unit 32 inputs a vehicle exterior image into the classifier to identify the area corresponding to the road shoulder or the evacuation space on the vehicle exterior image. When the vehicle 10 includes a range sensor, such as a LiDAR sensor, the vehicle control unit 32 may detect an obstacle, based on a ranging signal obtained by the range sensor. In this case also, the vehicle control unit 32 can detect an obstacle by inputting a ranging signal into a classifier that has been trained to detect an obstacle. When an obstacle is detected, the vehicle control unit 32 determines whether the obstacle is on the road shoulder or the evacuation space by referring to the direction and distance to the obstacle indicated by the ranging signal, the position and orientation of the vehicle 10, and the distance from the position of the vehicle 10 to the road shoulder or the evacuation space in the direction where the obstacle exists.

When a target stopping position is found, the vehicle control unit 32 controls components of the vehicle 10 to stop the vehicle 10 at the target stopping position. When the host vehicle lane being traveled by the vehicle 10 differs from a lane from which the road shoulder or the evacuation space can be entered, the vehicle control unit 32 controls the steering wheel of the vehicle 10 to make a lane change of the vehicle 10 to the lane from which the road shoulder or the evacuation space can be entered before the vehicle 10 reaches the target stopping position.

The vehicle control unit 32 identifies the host vehicle lane and the lane from which the road shoulder or the evacuation space can be entered, by referring to the positions of individual lanes represented in map information and the position of the vehicle 10 indicated by a positioning signal. Alternatively, the vehicle control unit 32 may detect individual lane lines on the road section being traveled by the vehicle 10, by inputting a vehicle exterior image into a classifier that has been trained to detect lane lines. The classifier is configured as a DNN having CNN-type architecture or an attention mechanism, similarly to the classifier for detecting an obstacle.

Alternatively, the classifier for detecting an obstacle may be pre-trained to detect lane lines as well. The vehicle control unit 32 identifies the number of lanes from the host vehicle lane to the lane from which the road shoulder or the evacuation space can be entered, based on the number of lane lines on the left or right of the vehicle 10.

In addition, the vehicle control unit 32 controls the vehicle 10 so that the vehicle 10 does not collide with any of obstacles around the vehicle 10 until the vehicle 10 stops.

The vehicle control unit 32 tracks obstacles around the vehicle 10 detected from time-series vehicle exterior images, and estimates predicted trajectories of the respective obstacles to a predetermined time ahead from the trajectories obtained from the result of tracking. Specifically, the vehicle control unit 32 applies a predetermined tracking process, such as Byte Track, to the series of vehicle exterior images to track the obstacles.

For each obstacle being tracked, the vehicle control unit 32 executes viewpoint transformation, using parameters of the vehicle exterior camera 2 such as the position of mounting on the vehicle 10, thereby transforming the image coordinates of the obstacle into coordinates in an aerial image (“aerial image coordinates”). To this end, the vehicle control unit 32 can estimate the position of the detected obstacle at the time of acquisition of each vehicle exterior image, using the position of the vehicle 10 measured by the position determining device, the travel direction of the vehicle 10 measured by the orientation sensor, an estimated distance to the detected obstacle, and the direction from the vehicle 10 to the obstacle at the time of acquisition of each vehicle exterior image. The bottom position of an object region representing a detected obstacle is supposed to correspond to the position at which the obstacle is on the road surface. Thus the vehicle control unit 32 can determine the estimated distance to the detected obstacle, based on the bottom position of the object region in the vehicle exterior image and parameters of the vehicle exterior camera 2, such as the orientation and the height of the mounted position. Alternatively, the vehicle control unit 32 may determine the distance measured by the range sensor in the direction corresponding to the object region representing the detected obstacle as the estimated distance to the detected obstacle. For each obstacle being tracked, the vehicle control unit 32 can estimate the trajectory of the obstacle by arranging the estimated positions in chronological order. The vehicle control unit 32 can then estimate predicted trajectories of the obstacles being tracked to a predetermined time ahead by executing a prediction process with, for example, a Kalman filter or a particle filter, based on the trajectories of the obstacles in a most recent predetermined period.

The vehicle control unit 32 controls components of the vehicle 10 (the power train, brake devices 13, and steering wheel), based on the predicted trajectories of the obstacles being tracked, so that predicted distances between the vehicle 10 and the obstacles will be greater than or equal to a predetermined distance until the predetermined time ahead. For example, assume that the vehicle 10 travels along the current path at the current speed and acceleration/deceleration, and that one of the detected obstacles moves along a predicted trajectory of the obstacle. Then, the vehicle control unit 32 decelerates the vehicle 10 or changes the travel direction of the vehicle 10, in the case where the vehicle 10 is predicted to collide with the obstacle, and where an estimated time until the collision is not longer than a predetermined collision determination time.

When the vehicle 10 stops at the target stopping position, the vehicle control unit 32 unlocks the doors and keeps honking the horn in an aid phase. The vehicle control unit 32 may report an abnormality occurring in the driver via a wireless communication terminal (not illustrated) mounted on the vehicle 10.

In the present embodiment, when decelerating the vehicle 10 to a low speed in the driving intervention phase, the vehicle control unit 32 sets the ratio of braking force of rear wheels 12 of the vehicle 10 to braking force of front wheels 11 of the vehicle 10 (the ratio will be referred to as the “braking force ratio” below), depending on the type of abnormality occurring in the driver. In the present embodiment, when the abnormality occurring in the driver is a first type of abnormality that does not allow jolting the driver, the vehicle control unit 32 decelerates the vehicle 10 by controlling the brake devices 13 so that the braking force ratio is a first ratio.

When the abnormality occurring in the driver is a second type of abnormality different from the first type, the vehicle control unit 32 decelerates the vehicle 10 by controlling the brake devices 13 so that the braking force ratio is a second ratio.

The second ratio is the ratio of braking force of the rear wheels 12 to braking force of the front wheels 11 for the case where the vehicle 10 decelerates when an abnormality occurring in the driver is not detected; the first ratio is set to a value greater than the second ratio. Setting the braking force ratio to the first ratio reduces pitching that occurs in the vehicle 10 at decelerating, and thus reduces jolts of the driver.

Examples of the first type of abnormality that does not allow jolting the driver include the symptoms of epilepsy appearing in the driver and those of a stroke appearing in the driver.

The first type of abnormality is preregistered in the memory 22. Examples of the second type of abnormality include the state in which the driver's sleepiness level is too high to drive. When the value of the flag received from the abnormality detection unit 31 and indicating the type of abnormality occurring in the driver matches a value corresponding to one of types of abnormality corresponding to the preregistered first type, the vehicle control unit 32 sets the braking force ratio to the first ratio. When the value of the flag indicating the type of abnormality occurring in the driver does not match any of values corresponding to the types of abnormality corresponding to the preregistered first type, the abnormality occurring in the driver is a second type of abnormality, and the vehicle control unit 32 sets the braking force ratio to the second ratio.

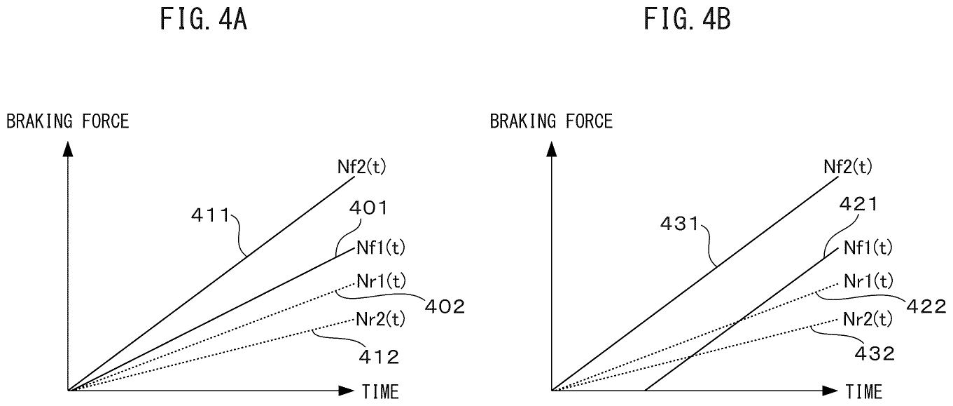

FIGS. 4A and 4B illustrate examples of time-varying changes in the braking force of the front wheels 11 and the rear wheels 12 for the case where the vehicle 10 decelerates. In FIGS. 4A and 4B, the abscissas represent time, and the ordinates represent braking force.

In FIG. 4A, graphs 401 and 402 represent time-varying changes in the braking force Nf1(t) of the front wheels 11 and the braking force Nr1(t) of the rear wheels 12 for the case where an abnormality occurring in the driver is a first type of abnormality, i.e., where the braking force ratio is set to the first ratio, respectively. Graphs 411 and 412 represent time-varying changes in the braking force Nf2(t) of the front wheels 11 and the braking force Nr2(t) of the rear wheels 12 for the case where an abnormality occurring in the driver is a second type of abnormality, i.e., where the braking force ratio is set to the second ratio, respectively. As illustrated by the graphs 401, 402, 411, and 412, the braking force of the front wheels 11 and the rear wheels 12 increases monotonously with the passage of time, regardless of the value of the braking force ratio. However, the braking force Nf1(t) of the front wheels 11 for the case where the braking force ratio is set to the first ratio is set to a value less than the braking force Nf2(t) of the front wheels 11 for the case where the braking force ratio is set to the second ratio. The braking force Nr1(t) of the rear wheels 12 for the case where the braking force ratio is set to the first ratio is set to a value greater than the braking force Nr2(t) of the rear wheels 12 for the case where the braking force ratio is set to the second ratio. This suggests that the first ratio (Nr1(t)/Nf1(t)) has a greater value than the second ratio (Nr2(t)/Nf2(t)).

In FIG. 4B, graphs 421 and 422 represent time-varying changes in the braking force Nf1(t) of the front wheels 11 and the braking force Nr1(t) of the rear wheels 12 for the case where an abnormality occurring in the driver is a first type of abnormality, i.e., where the braking force ratio is set to the first ratio, respectively. Graphs 431 and 432 represent time-varying changes in the braking force Nf2(t) of the front wheels 11 and the braking force Nr2(t) of the rear wheels 12 for the case where an abnormality occurring in the driver is a second type of abnormality, i.e., where the braking force ratio is set to the second ratio, respectively. In the example illustrated in FIG. 4B, when the braking force ratio is set to the first ratio, the brake devices 13 are controlled so that the braking force Nf1(t) of the front wheels 11 rises later than when the braking force ratio is set to the second ratio. This suggests that even in this case, the first ratio (Nr1(t)/Nf1(t)) has a greater value than the second ratio (Nr2(t)/Nf2(t)).

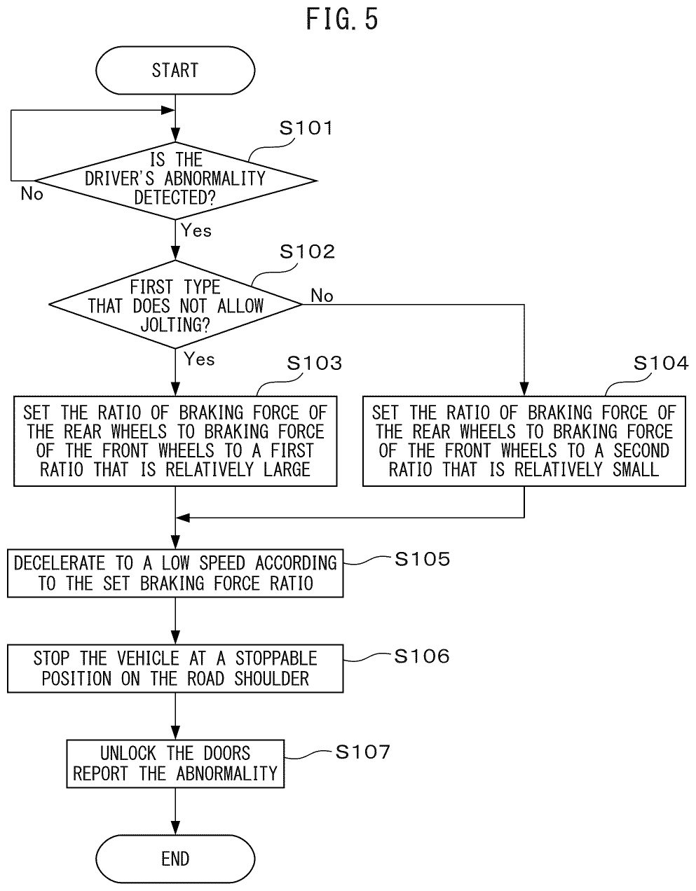

FIG. 5 is an operation flowchart of the vehicle control process executed by the processor 23.

The abnormality detection unit 31 determines whether abnormality occurring in the driver is detected (step S101). When an abnormality occurring in the driver is not detected (No in step S101), the processor 23 repeats the processing of step S101.

When an abnormality occurring in the driver is detected (Yes in step S101), the vehicle control unit 32 determines whether the type of abnormality occurring in the driver identified by the abnormality detection unit 31 is a first type that does not allow jolting the driver (step S102). When the type of abnormality is the first type (Yes in step S102), the vehicle control unit 32 sets the ratio of braking force of the rear wheels 12 to braking force of the front wheels 11 to a first ratio that is relatively large (step S103). When the type of abnormality is not the first type, i.e., when it is a second type (No in step S102), the vehicle control unit 32 sets the ratio of braking force of the rear wheels 12 to braking force of the front wheels 11 to a second ratio that is relatively small (step S104).

After step S103 or S104, the vehicle control unit 32 controls the brake devices 13 according to the set braking force ratio to decelerate the vehicle 10 to a low speed (step S105).

Thereafter, the vehicle control unit 32 searches the road shoulder or an evacuation space for a space where the vehicle 10 can stop, and stops the vehicle 10 in the space (step S106).

Thereafter, the vehicle control unit 32 unlocks the doors and reports an abnormality occurring in the driver (step S107). The processor 23 then terminates the vehicle control process.

As has been described above, when making an emergency stop of the vehicle in response to detection of an abnormality occurring in the driver, the vehicle controller sets the ratio of braking force of rear wheels of the vehicle to braking force of front wheels of the vehicle, depending on the type of the abnormality occurring in the driver. In particular, when the type of abnormality occurring in the driver is such that jolting the driver is not allowed, the vehicle controller sets the ratio of braking force of the rear wheels to braking force of the front wheels to a greater value than when the driver is in a normal state. By setting the braking force ratio in this way, the vehicle controller can reduce pitching of the vehicle at decelerating to reduce jolts of the vehicle at decelerating the vehicle in response to the abnormality occurring in the driver.

According to a modified example, the abnormality detection unit 31 may detect an abnormality occurring in the driver and identify the type of abnormality occurring in the driver, based on a voice collected by a microphone (not illustrated) provided inside the vehicle, instead of or together with driver images. The microphone is another example of the vehicle interior sensor; a voice signal representing a collected voice and generated by the microphone is another example of the interior sensor signal. In this case, the abnormality detection unit 31 identifies the presence or absence of an abnormality occurring in the driver and, when abnormality is detected, the type of abnormality by inputting a voice signal (and driver images) into a classifier that has been trained to detect a driver's abnormality from a voice signal (and driver images) and to identify the type of the detected abnormality. In this modified example also, the classifier is configured as a DNN having a recursive structure, such as a RNN or LSTM.

Similarly, the abnormality detection unit 31 may detect an abnormality occurring in the driver and identify the type of abnormality occurring in the driver, based on a sensor signal indicating the driver's heart rate and generated by a radar sensor (not illustrated) provided inside the vehicle, instead of or together with driver images. The radar sensor is still another example of the vehicle interior sensor; a sensor signal generated by the radar sensor is still another example of the interior sensor signal. In this case also, the abnormality detection unit 31 identifies the presence or absence of an abnormality occurring in the driver and, when abnormality is detected, the type of abnormality by inputting a sensor signal (and driver images) into a classifier for detecting abnormality.

According to another modified example, when decelerating the vehicle 10 to a predetermined low speed according to emergency stop mode, the vehicle control unit 32 may set the ratio of braking force of the rear wheels 12 to braking force of the front wheels 11 to the first ratio, regardless of the type of abnormality occurring in the driver. In this modified example also, pitching of the vehicle 10 is reduced during deceleration caused by execution of emergency stop mode in response to detection of an abnormality occurring in the driver, so that jolts of the driver at decelerating are reduced.

The computer program for achieving the vehicle control process of the above-described embodiment or modified example may be provided in recorded form on a computer-readable portable storage medium.

As described above, those skilled in the art may make various modifications according to embodiments within the scope of the present invention.

What is claimed is:

1. A vehicle controller comprising:
a processor configured to:
detect abnormality occurring in a driver of a vehicle,
decelerate the vehicle so that a ratio of braking force of rear wheels of the vehicle to braking force of front wheels of the vehicle is a first ratio, when abnormality occurring in the driver is detected, and
set the first ratio to a value greater than a second ratio, the second ratio being the ratio of braking force of the rear wheels to braking force of the front wheels for a case where the vehicle decelerates when an abnormality occurring in the driver is not detected.

2. The vehicle controller according to claim 1, wherein the processor identifies a type of abnormality occurring in the driver, based on an interior sensor signal obtained by a vehicle interior sensor for sensing the driver's state, and
the processor decelerates the vehicle at the first ratio when the type of abnormality occurring in the driver is a first type that does not allow jolting the driver, and decelerates the vehicle at the second ratio when the type of abnormality occurring in the driver is a second type different from the first type.

3. A method for vehicle control, comprising:
detecting abnormality occurring in a driver of a vehicle;
decelerating the vehicle so that a ratio of braking force of rear wheels of the vehicle to braking force of front wheels of the vehicle is a first ratio, when abnormality occurring in the driver is detected; and
setting the first ratio to a value greater than a second ratio, the second ratio being the ratio of braking force of the rear wheels to braking force of the front wheels for a case where the vehicle decelerates when an abnormality occurring in the driver is not detected.

4. A non-transitory recording medium that stores a computer program for vehicle control, the computer program causing a processor mounted on a vehicle to execute a process comprising:
detecting abnormality occurring in a driver of the vehicle;
decelerating the vehicle so that a ratio of braking force of rear wheels of the vehicle to braking force of front wheels of the vehicle is a first ratio, when abnormality occurring in the driver is detected; and
setting the first ratio to a value greater than a second ratio, the second ratio being the ratio of braking force of the rear wheels to braking force of the front wheels for a case where the vehicle decelerates when an abnormality occurring in the driver is not detected.
